(19) United States
(12) Patent Application Publication
(10) Pub. No.: US 2026/0335966 A1
(43) Pub. Date: Oct. 29, 2026

(54) SYSTEM AND TOOL FOR INSTALLING ADVANCED FASTENERS ONTO A U-BOLT

(71) Applicant: Howmet Aerospace Inc., Pittsburgh, PA (US)

(72) Inventors: Thomas R. Kingsbury, Hewitt, TX (US); Scott M. McIntosh, Kingston, NY (US)

(21) Appl. No.: 19/103,908

(22) PCT Filed: Jul. 25, 2023
(86) PCT No.: PCT/US2023/028539

§ 371 Date: Feb. 14, 2025

Related U.S. Application Data
(60) Provisional application No. 63/398,591, filed on Aug. 17, 2022.

(51) Int. Cl. B21J 15/02; B21J 15/20; B21J 15/28

(52) U.S. Cl. CPC B21J 15/022; B21J 15/20; B21J 15/28

(57) ABSTRACT

An installation tool adapted to install fasteners onto a U-bolt is provided. The installation tool includes a frame, a tool mount affixed to the frame, and a pair of arms each having a proximal end pivotally affixed to the tool mount and a fastening tool disposed at a distal end. Each fastening tool includes a grooved portion configured to affix to corresponding annular pull grooves of the U-bolt, a limit switch configured to indicate when the grooved portion is in alignment with the corresponding annular pull grooves, and a swaging anvil. The installation tool also includes a hydraulic system configured to pull the grooved portion of the fastening tool and to cause the swaging anvil to swage a sleeve into a lock grooved portion of the U-bolt and a controller configured to operate the hydraulic system based on a state of the limit switches.

### BACKGROUND

The present disclosure relates to a tool, and more particularly to an installation system for installing advanced fasteners onto a U-bolt.

Various types of fasteners are known and understood in the relevant art to fasten structures to one another. Among the various types of fasteners are threaded fasteners such as nuts, bolts, screws, and the like, deformable fasteners such as rivets and deformable threaded systems, and specially configured, among numerous other types of fasteners such as adhesives and welding operations. In certain applications, it is desired that certain fasteners have highly specific characteristics.

### SUMMARY

An installation tool according to one, non-limiting, embodiment of the present disclosure is adapted to install advanced fasteners onto a U-bolt. The installation tool includes a frame, a tool mount affixed to the frame by a secondary actuator, and a pair of arms, each of the pair of arms having a proximal end pivotally affixed to the tool mount and a fastening tool disposed at a distal end. Each fastening tool includes a grooved portion configured to affix to corresponding annular pull grooves of the U-bolt, a limit switch configured to indicate when the grooved portion is in alignment with the corresponding annular pull grooves, and a swaging anvil. The installation tool also includes a hydraulic system configured to pull the grooved portion of the fastening tool and to cause the swaging anvil to swage a sleeve into a lock grooved portion of the U-bolt and a controller configured to operate the secondary actuator and the hydraulic system based at least in part on a state of the limit switch of each of the pair of arms.

In the alternative or additionally thereto, in the foregoing embodiment, the controller is configured to prevent the hydraulic system from operating unless each limit switch of each of the pair of arms indicates that the grooved portion of the associated arm is in alignment with the corresponding annular pull grooves of the U-bolt.

In the alternative or additionally thereto, in the foregoing embodiment, the secondary actuator is a linear actuator and the controller is configured to move the tool mount via the linear actuator based on a determination that at least one limit switch indicates that the grooved portion is not in alignment with the annular pull grooves.

In the alternative or additionally thereto, in the foregoing embodiment, the installation tool further includes a user interface configured to receive a user input, wherein the controller is further configured to operate the secondary actuator and the hydraulic system based at least in part on the user input.

In the alternative or additionally thereto, in the foregoing embodiment, the user input includes a command to activate the hydraulic system.

In the alternative or additionally thereto, in the foregoing embodiment, the controller is configured to activate the hydraulic system, responsive to the user input, based on a determination that each limit switch of each of the pair of arms indicates that the grooved portion of the associated arm is in alignment with the corresponding annular pull grooves of the U-bolt.

In the alternative or additionally thereto, in the foregoing embodiment, the installation tool further includes a restrictor plate configured to limit a horizontal movement of each of the pair of arms.

A control system for an installation tool of fasteners onto a U-bolt according to one, non-limiting, embodiment of the present disclosure is provided. The control system includes a first actuator configured to adjust a position of the installation tool with respect to the U-bolt and a second actuator configured to adjust a vertical position of a tool mount disposed within a body of the installation tool. The control system also includes a plurality of limit switches each configured to indicate an alignment status of an associated grooved portion of the installation tool with corresponding annular pull grooves of the U-bolt, a hydraulic system configured to pull the grooved portions of the installation tool and to cause swaging anvils of the installation tool to swage sleeves into lock grooved portions of the U-bolt, and a controller configured to operate the first actuator, the second actuator, and the hydraulic system based at least in part on a user input and a state of the plurality of limit switches.

In the alternative or additionally thereto, in the foregoing embodiment, the controller is configured to prevent the hydraulic system from being activated unless each of the plurality of limit switches indicates that the associated grooved portion is in alignment with the corresponding annular pull grooves of the U-bolt.

In the alternative or additionally thereto, in the foregoing embodiment, the controller is configured to move the tool mount via the second actuator based on a determination that: (a) at least one of the plurality of limit switches indicates that the associated grooved portion is not in alignment with the corresponding annular pull grooves; and (b) at least one of the plurality of limit switch indicates that the associated grooved portion is in alignment with the corresponding annular pull grooves.

In the alternative or additionally thereto, in the foregoing embodiment, the user input is received by the controller from a user interface.

In the alternative or additionally thereto, in the foregoing embodiment, the user input includes a command to activate the hydraulic system.

In the alternative or additionally thereto, in the foregoing embodiment, the controller is configured to activate the hydraulic system, responsive to the user input, based on a determination that the limit switch of each of the pair of arms indicates that the associated grooved portion is in alignment with the corresponding annular pull grooves.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIGS. 1A, 1B, 1C, 1D, and 1E are cross-sectional views of an advanced fastener for use with the installation system in accordance with an exemplary embodiment of the present disclosure;

FIG. 2A is a cross-sectional view of a U-bolt in accordance with an exemplary embodiment of the present disclosure;

FIG. 2B is a perspective view of a tool for installing advanced fasteners onto a U-bolt in accordance with an exemplary embodiment of the present disclosure;

FIG. 3 is a cross-sectional view of a portion of a tool for installing advanced fasteners onto a U-bolt in accordance with an exemplary embodiment of the present disclosure;

FIG. 4 is a cross-sectional view of another portion of a tool for installing advanced fasteners onto a U-bolt in accordance with an exemplary embodiment of the present disclosure;

FIGS. 5A and 5B are, perspective and cross-sectional views respectively, of a tool for installing advanced fasteners onto a U-bolt in accordance with an exemplary embodiment of the present disclosure;

FIG. 5C is a top view of a restrictor plate of a tool for installing advanced fasteners onto a U-bolt in accordance with an exemplary embodiment of the present disclosure; and

FIG. 6 is a block diagram of a system for controlling the operation of a tool for installing advanced fasteners onto a U-bolt in accordance with an exemplary embodiment of the present disclosure.

### DETAILED DESCRIPTION

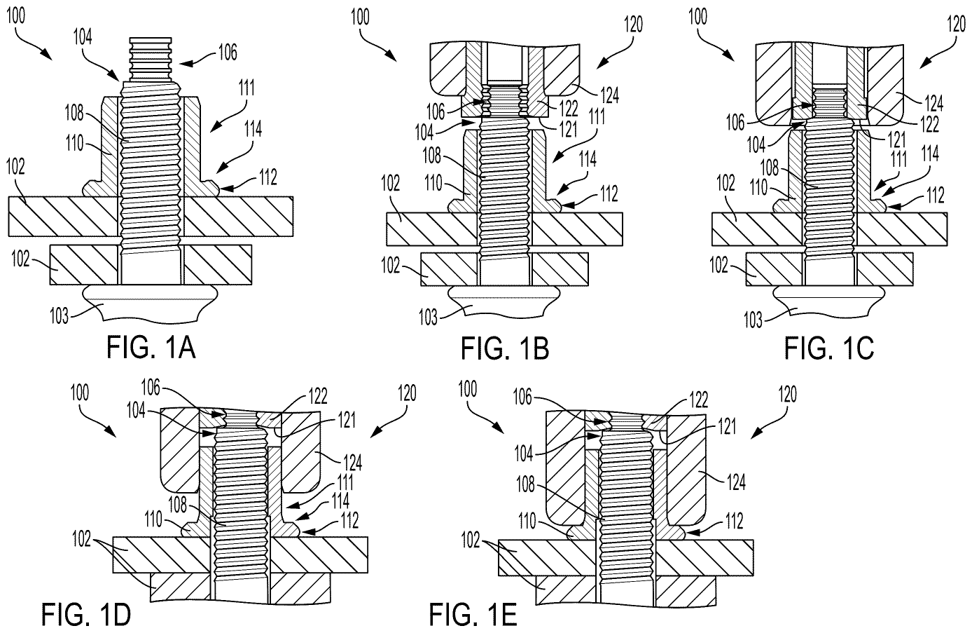

Referring to FIGS. 1A, 1B, 1C, 1D, and 1E cross-sectional views of an advanced fastener 100 during various stages of fastening are illustrated. The advanced fastener 100 generally includes a pin 104 and a sleeve 110. The pin 104 is configured to be inserted through holes of one or more pieces of material 102 to fasten the one or more pieces of material 102 together. The pin 104 includes a head, a first grooved portion 108, and a second grooved portion 106. In exemplary embodiments, the outer diameter of the first grooved portion 108 is greater than the outer diameter of the second grooved portion 106. In exemplary embodiments, the first grooved portion 108 includes a series of grooves, which may be annular or helical grooves, and the second grooved portion 106 includes a series of annular grooves. The sleeve 110 includes body portion 111 and a collar portion 112, which includes one or more indicators 114 on an upper surface of the collar portion 112.

In exemplary embodiments, a fastening tool 120 is configured to fasten the advanced fastener 100 using the following procedure. First, the fastening tool 120 is placed onto the pin 104 such that a bottom surface 121 of the fastening tool 120 contacts an upper surface of the first grooved portion 108, as best shown in FIG. 1B. Next, as best shown in FIG. 1C, the grooved portion 122 of the fastening tool 120 engages with the second grooved portion 106 of the advanced fastener 100.

After the fastening tool 120 is applied to the second grooved portion 106, a hydraulic puller (not shown) is activated to draw the pin 104 into the tool, causing the swaging anvil 124 to press on the sleeve 110, drawing up a gap between the one or more pieces of material 102, as best shown in FIG. 1D. At a predetermined force, the swaging anvil 124 begins to swage the sleeve 110 into the first grooved portion 108 of the pin 104, as best shown in FIG. 1E. Continued swaging elongates the sleeve 110 relative to the pin 104, developing a precise preload between the pin and the sleeve. When swaging of the sleeve 110 into the first grooved portion 108 of the pin 104 is complete, the fastening tool 120 ejects the fastener 100 and releases the puller to complete the sequence. As used herein the term swage means to press into, i.e., swaging the sleeve 110 into the first groove portion 108 of the pin 104 means pressing the sleeve into the first groove portion 108.

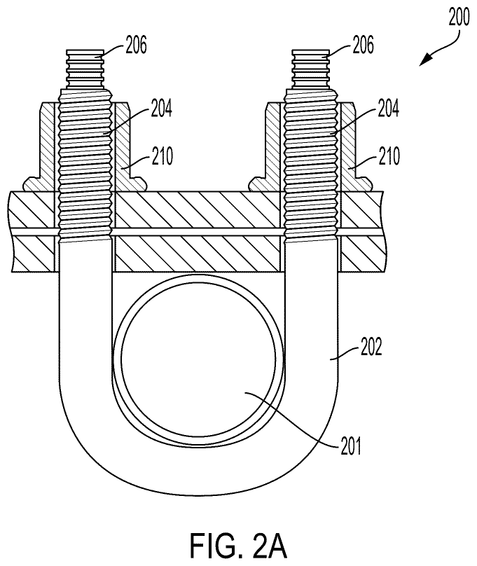

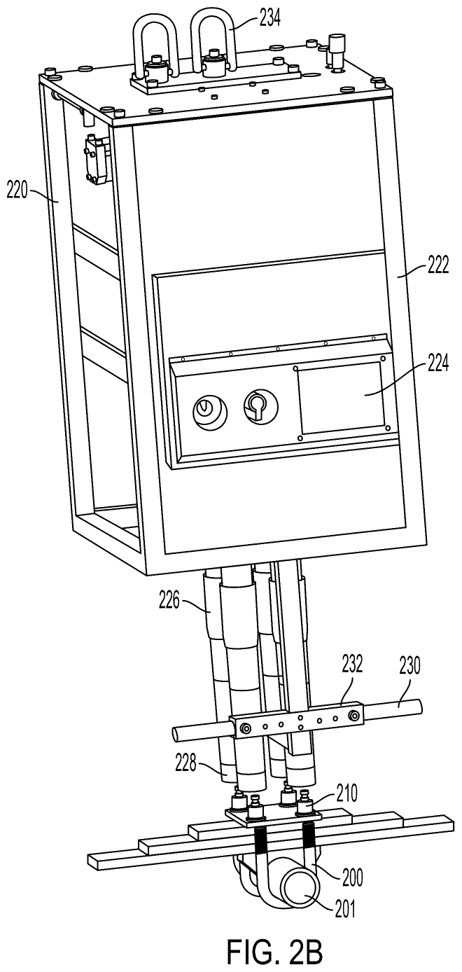

FIG. 2A illustrates a U-bolt 200 for use with the advanced fastening system described herein to secure a structure such as a rod 201. As illustrated, the U-bolt 200 includes a body portion 202, two lock groove portions 204, and two pull groove portions 206. In exemplary embodiments, the outer diameter of the lock grooved portions 204 is greater than the outer diameter of the pull groove portions 206. In exemplary embodiments, the lock groove portions 204 include a series of helical grooves, and the pull groove portions 206 include a series of annular grooves. Sleeves 210 are configured to be placed over the lock grooved portions 204 and swaged into the lock grooved portions 204 during fastening.

In exemplary embodiments, installing advanced fasteners onto a U-bolt requires that the installation of both fasteners happen substantially simultaneously. Attempting to install a single fastener onto one end of the U-bolt at a time can lead to deformation of the U-bolt.

Referring now to FIG. 2B, a tool 220 for installing advanced fasteners onto a U-bolt 200, such as the one shown in FIG. 2A, in accordance with an exemplary embodiment of the present disclosure is shown. In exemplary embodiments, the tool 220 is configured to install fasteners on both ends of a U-bolt 200 substantially simultaneously. As illustrated, the tool 220 includes a body portion 222 that includes a user interface 224, which is configured to permit a user to control the operation of the tool 220. The tool 220 includes at least one pair of arms 226 that each have a distal end 228 that is configured to engage with the pull groove portions 206 of the U-bolt 200. The tool 220 further includes a handle 230 that allows the user to adjust the position of the at least one pair of arms 226. In one embodiment, the handle 230 includes one or more buttons 232 that can be used to initiate the installation cycle. In one embodiment, both of the buttons must be pressed simultaneously to initiate the installation cycle. In exemplary embodiments, the tool 220 includes one or more hooks 234 that are configured to connect the tool to a primary actuator (not shown) that is used to control the position of the tool 220.

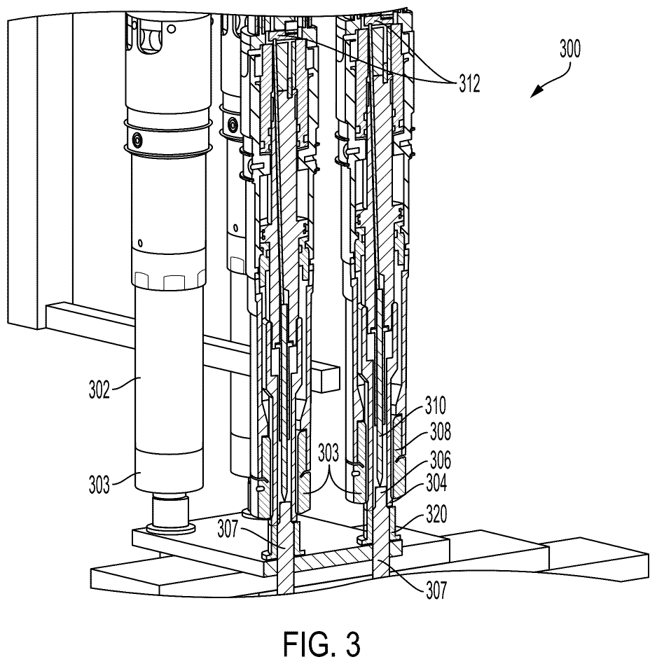

Referring now to FIG. 3 a cross-sectional view of a portion of a tool 300 for installing advanced fasteners onto a U-bolt in accordance with an exemplary embodiment of the present disclosure is shown. As illustrated, each of the arms 302 includes a fastening tool 303 at its distal end. The fastening tool 303 includes a grooved portion 304 that is configured to engage with a pull groove portion 306 of the U-bolt. The fastening tool 303 further includes a swaging anvil 308 that is configured to swage the sleeve 320 into a lock grooved portion 307 of the U-bolt, once the tool 300 has been activated.

In exemplary embodiments, each arm 302 of the tool 300 includes a rod 310 that is affixed at the proximal end to a limit switch 312. The rod 310 extends down the inside of the arm 302 and the distal end of the rod 310 is configured to make contact with an upper portion of the pull groove portion 306 of the U-bolt. In exemplary embodiments, the length of the arm 302 is configured such that the limit switch 312 is activated only when the grooved portion 304 of the fastening tool 303 has been placed into alignment with the pull groove portion 306 of the U-bolt. In one embodiment, the determination that the grooved portion 304 of the fastening tool 303 has been placed into alignment with the pull groove portion 306 of the U-bolt, is based on determining that the grooved portion 304 of the fastening tool 303 overlaps the entire pull groove portion 306 of the U-bolt. In another embodiment, the determination that the grooved portion 304 of the fastening tool 303 has been placed into alignment with the pull groove portion 306 of the U-bolt, is based on determining that the grooved portion 304 of the fastening tool 303 overlaps a threshold percentage of the pull groove portion 306 of the U-bolt.

In exemplary embodiments, the tool 300 is configured to not activate unless each limit switch 312 indicates that its associated grooved portion 304 of the fastening tool 303 has been placed into alignment with the corresponding pull groove portion 306 of the U-bolt for each arm 302. Once the tool has been properly placed, i.e., once all of limit switch 312 are in an on position, the tool can be activated. Once activated, the tool 300 is configured to simultaneously engage each the grooved portions 304 of the fastening tool 303 with the corresponding pull groove portions 306 of the U-bolt. Next, the tool 300 uses a hydraulic system (not shown) to pull up on the pull groove portions 306 which draws the lock grooved portions 307 into the fastening tools 303, causing the swaging anvils 308 to press on the sleeves 320, removing any gaps in the material being fastened. At a predetermined force, the swaging anvils 308 begin to swage the sleeves 320 into the lock grooved portions 307. Continued swaging elongates the sleeves 320 relative to the lock grooved portions 307, developing a precise clamp.

When swaging of the sleeves 320 into the lock grooved portions 307 is complete, the tool ejects the fastening tools 303 and releases the grooved portions 304 of the fastening tools 303 to complete the sequence. In exemplary embodiments, the determination that the swaging process is complete is based on the force of the hydraulic system operating the tool 300 reaching a threshold level. In exemplary embodiments, the threshold level is based on the characteristics of the U-bolt and/or the sleeve 320.

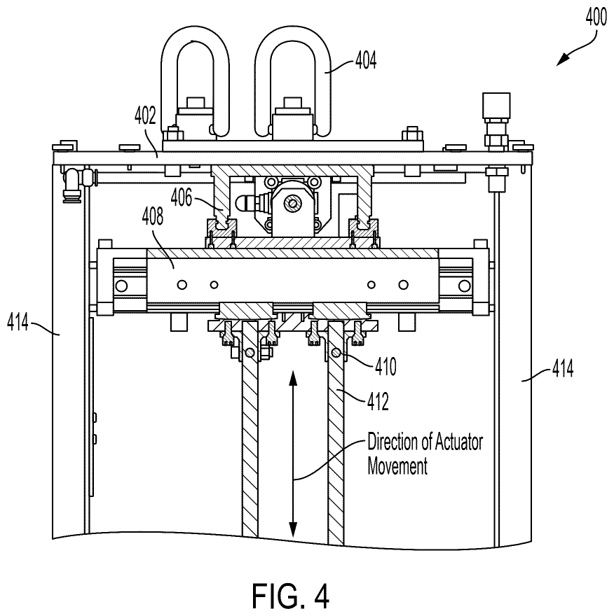

Referring now to FIG. 4 a cross-sectional view of another portion of a tool 400 for installing advanced fasteners onto a U-bolt in accordance with an exemplary embodiment of the present disclosure is shown. As illustrated, the tool 400 includes a frame 402 that has one or more hooks 404 affixed to an upper surface of the frame 402. In exemplary embodiments, the one or more hooks 404 are configured to connect the tool 400 to a primary actuator (not shown) that is used to control the position of the tool 400. The tool 400 also includes a tool mount 408 that is connected to the frame 402 by a secondary actuator 406, also referred to herein as a linear actuator 406. The secondary actuator 406 is configured to move the tool mount 408 up and down, in the direction illustrated, between the sidewalls 414 of the tool 400. The tool 400 further includes one or more pairs of arms 412 that are each pivotally affixed to the tool mount 408 at joints 410. In exemplary embodiments, the secondary actuator 406 is used to position the arms 412 such that fastening tools at the distal ends of the arms engage with a U-bolt.

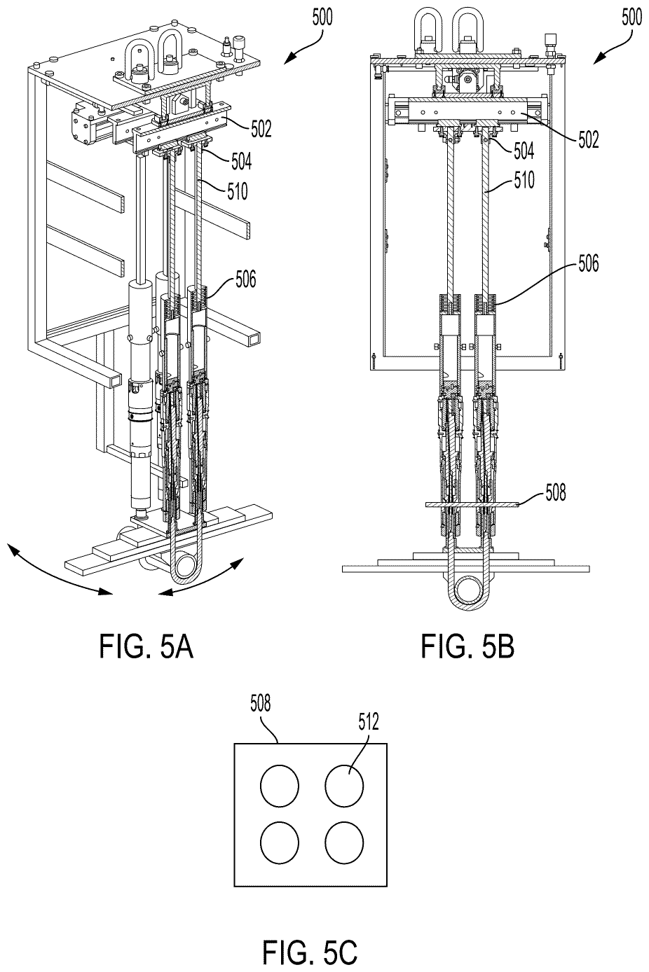

Turning now to FIGS. 5A and 5B perspective and cross-sectional views respectively, of a tool 500 for installing advanced fasteners onto a U-bolt in accordance with an exemplary embodiment of the present disclosure are shown. As illustrated, the tool 500 includes one or more pairs of arms 510 that are pivotally affixed to a tool mount 502 by a joint 504. In exemplary embodiments, the joints 510 are configured to allow the arms 510 to freely swing in multiple directions to allow a user to align a fastening tool at the distal end of the arm 510 with a U-bolt. In exemplary embodiments, each arm 510 includes a spring 506 that allows the arms to be able to move relative to one another in the vertical direction to compensate for movement of the tool 500 and varying speeds of swaging each fastener. In some embodiments, the tool 500 includes a restrictor plate 508 that is configured to limit the amount that each arm 510 can swing in any direction and prevent the arms from impacting one another.

FIG. 5C is a top view of a restrictor plate 508 of a tool for installing advanced fasteners onto a U-bolt in accordance with an exemplary embodiment of the present disclosure. As illustrated, the restrictor plate 508 includes an aperture 512 corresponding to each arm 510 of the tool 500. In exemplary embodiments, the size of the apertures 512 is configured to permit only a desired amount of freedom of

### Movement of the Arms 510.

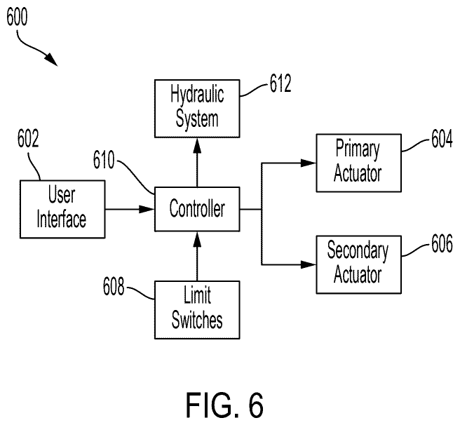

Referring now to FIG. 6 a block diagram of a system 600 for controlling the operation of a tool for installing advanced fasteners onto a U-bolt in accordance with an exemplary embodiment of the present disclosure is shown. As shown, the system 600 includes a user interface 602 that is configured to receive inputs from a user. The user interface 602 can include one or more buttons, a touchscreen device, and the like. The system 600 also includes a controller 610 that is configured to receive input from the user interface 602 and to responsively control the operation of a primary actuator 604, a secondary actuator 606, and a hydraulic system 612. In exemplary embodiments, the controller 610 may be any suitable processing device, such as a general-purpose processor, a flexible programmable gate array (FPGA), an application-specific integrated circuit (ASIC), or the like.

In exemplary embodiments, the primary actuator 604 is configured to move the tool for installing advanced fasteners onto a U-bolt responsive to commands from the controller 610, which in turn are based on user input received from the user interface 602. In exemplary embodiments, once the controller 610 receives a command from the user interface 602 to activate the tool, via the hydraulic system 612, the controller 610 is configured to determine the status of one or more limit switches 608. Based on a determination that all of the limit switches have been activated, the controller 610 activates the tool using the hydraulic system 612. In exemplary embodiments, each arm of the tool includes a limit switch that is activated when a grooved portion of the arm has been placed into alignment with a corresponding pull groove portion of the U-bolt.

In exemplary embodiments, based on a determination that some, but not all of the limit switches, have been activated, the controller 610 activates the secondary actuator 606, which responsively moves the arm(s) for which a limit switch signal has not been received towards the U-bolt to aid in the alignment of the associated grooved portion of the applicable arms(s) with the corresponding pull groove portion(s) of the U-bolt. Once all limit switch signals are received by the controller 10, the controller 610 will activate the tool via the hydraulic system 612.

Advantages and benefits regarding the installation tool and system include the ability to simultaneously install advanced fasteners onto both sides of a U-bolt having a set on annular pull groves. In exemplary embodiments, the user of annular pull grooves, as opposed to helical pull grooves, reduces the complexity of the installation tool as the installation tool is not required to have any rotating members.

While the present disclosure is described with reference to the figures, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. An installation tool adapted to install fasteners onto a U-bolt, the installation tool comprising:
a frame;
a tool mount affixed to the frame by a secondary actuator;
a pair of arms, each of the pair of arms having a proximal end pivotally affixed to the tool mount and a fastening tool disposed at a distal end, each fastening tool comprising:
a grooved portion configured to affix to corresponding annular pull grooves of the U-bolt;
a limit switch configured to indicate when the grooved portion is in alignment with the corresponding annular pull grooves; and
a swaging anvil;
a hydraulic system configured to pull the grooved portion of the fastening tool and to cause the swaging anvil to swage a sleeve into a lock grooved portion of the U-bolt; and
a controller configured to operate the secondary actuator and the hydraulic system based at least in part on a state of the limit switch of each of the pair of arms.

2. The installation tool of claim 1, wherein the controller is configured to prevent the hydraulic system from operating unless each limit switch of each of the pair of arms indicates that the grooved portion of the associated arm is in alignment with the corresponding annular pull grooves of the U-bolt.

3. The installation tool of claim 1, wherein the secondary actuator is a linear actuator and the controller is configured to move the tool mount via the linear actuator based on a determination that at least one limit switch indicates that the grooved portion is not in alignment with the annular pull grooves.

4. The installation tool of claim 1, further comprising a user interface configured to receive a user input, wherein the controller is further configured to operate the secondary actuator and the hydraulic system based at least in part on the user input.

5. The installation tool of claim 1, wherein the user input includes a command to activate the hydraulic system.

6. The installation tool of claim 5, wherein the controller is configured to activate the hydraulic system, responsive to the user input, based on a determination that each limit switch of each of the pair of arms indicates that the grooved portion of the associated arm is in alignment with the corresponding annular pull grooves of the U-bolt.

7. The installation tool of claim 1, further comprising a restrictor plate configured to limit a horizontal movement of each of the pair of arms.

8. A control system for an installation tool of fasteners onto a U-bolt, the control system comprising:
a first actuator configured to adjust a position of the installation tool with respect to the U-bolt;
a second actuator configured to adjust a vertical position of a tool mount disposed within a body of the installation tool;
a plurality of limit switches each configured to indicate an alignment status of an associated grooved portion of the installation tool with corresponding annular pull grooves of the U-bolt;
a hydraulic system configured to pull the grooved portions of the installation tool and to cause swaging anvils of the installation tool to swage sleeves into lock grooved portions of the U-bolt; and
a controller configured to operate the first actuator, the second actuator, and the hydraulic system based at least in part on a user input and a state of the plurality of limit switches.

9. The control system of claim 8, wherein the controller is configured to prevent the hydraulic system from being activated unless each of the plurality of limit switches indicates that the associated grooved portion is in alignment with the corresponding annular pull grooves of the U-bolt.

10. The control system of claim 8, wherein the controller is configured to move the tool mount via the second actuator based on a determination that: (a) at least one of the plurality of limit switches indicates that the associated grooved portion is not in alignment with the corresponding annular pull grooves; and (b) at least one of the plurality of limit switch indicates that the associated grooved portion is in alignment with the corresponding annular pull grooves.

11. The control system of claim 8, wherein the user input is received by the controller from a user interface.

12. The control system of claim 8, wherein the user input includes a command to activate the hydraulic system.

13. The control system of claim 12, wherein the controller is configured to activate the hydraulic system, responsive to the user input, based on a determination that the limit switch of each of the pair of arms indicates that the associated grooved portion is in alignment with the corresponding annular pull grooves.
